(19) United States
(12) Patent Application Publication
(10) Pub. No.: US 2010/0011824 A1
(43) Pub. Date: Jan. 21, 2010

(54) PROCESS TO OBTAIN POLYMERIC-NATURE CHEMICAL COMPOUNDS APPLIED TO FIXATION IN FERTILIZERS AND RELATED PRODUCTS

(76) Inventor: Antonio Carlos de Gissi Junior, Olimpia (BR)

Correspondence Address: SCULLY SCOTT MURPHY & PRESSER, PC, 400 GARDEN CITY PLAZA, SUITE 300, GARDEN CITY, NY, 11530, US

(21) Appl. No.: 12/374,558

(22) PCT Filed: Jul. 2, 2007
(86) PCT No.: PCT/BR2007/000172

§ 371 Date: Aug. 5, 2009

(30) Foreign Application Priority Data
Jul. 21, 2006 (BR) PI 0603127-7

(51) Int. Cl. C05F 5/00; C08K 11/00

(52) U.S. Cl. 71/27; 524/78

(57) ABSTRACT

A process for obtaining a poly-coat chemical compound applied for fixation of polymeric-nature elements in fertilizers and related products, making available a greater quantity of nutrients in the cultivation soil of several cultures, being this unique condition driving to economical gains, since there is a significant decrease of the total volume of fertilizer applied, and also ecological gains, since the decrease of the fertilizer volume decreases the contamination of groundwater

### FIELD OF THE INVENTION

The present invention is in the field of processes for obtaining a chemical compound.

### BACKGROUND OF THE INVENTION

It has always been a desire to reduce the quantity of fertilizer currently used by men. A decrease in the quantity of fertilizers used has many advantages, mainly from an economical and ecological point of view.

The need for application of high volumes of fertilizers generates a high level of soil salination. It is well known that that by reducing the use of fertilizers it is observed a significant decrease of contamination in groundwater, as well as the decrease of soil salination.

### SUMMARY OF THE INVENTION

The present invention seeks to provide obtainment of a chemical compound referred as poly-coat, which is applied, in a previously defined quantity, to fertilizers, in order to get a gradual release of nutrients to the soil.

The present invention seeks to provide a process for obtaining a poly-coat polymeric compound applied for fixation of polymeric-nature elements in fertilizers and related products, the process comprising the steps of: (a) feeding vinasse, powder molasses, acrylic copolymers and water in concentrations of 45%, 35%, 10% and 10%, respectively into a mixer; (b) mixing the compounds and the water in the mixer for a period of ten minutes; and then (c) obtaining a poly-coat chemical compound.

The present invention also seeks to provide a poly-coat chemical compound comprising: 45% vinasse; 35% powder molasses; 10% acrylic copolymers, and 10% water. The compound may be mixed to any kind of fertilizer

### DETAILED DESCRIPTION OF THE INVENTION

The chemical compound of the present invention aggregates values from the economical, agronomical and ecological point of view in the field of agricultural business.

From the economical point of view the chemical compound of the present invention allows for a greater general productivity of an agricultural culture, including a greater cultivation area, hence bringing a greater financial return to the farmer. Also from the economical point of view it is possible to decrease the quantity of applied fertilizer, decreasing fertilizing costs.

From the agricultural point of view, the chemical compound of the present invention allows farmers to have a better harvest quality of several and different cultures, translated into enrichment of the nutritional elements in the food.

The decrease in the quantity of fertilizer used has also advantages from the ecological point of view. With the chemical compound of the present invention it is possible to observe a significant decrease in the contamination of groundwater, as well as the decrease in the soil salination. These contaminations are due to the need for applications of high volumes of fertilizers.

When applied to the soil, the poly-coat chemical compound of the present invention allows for gradual release of fertilizers. The gradual release of polymers has its logic explained by the fact they have the capacity of retaining macro and micronutrients inside their helicoidal chains, releasing them in a gradual way, or when the roots enter inside these chains and absorb such elements

The composition characteristics and concentrations of the poly-coat chemical compound are below in Table 1.

TABLE 1

| Compound | Concentration (%) |
|---|---|
| Vinasse | 45 |
| Molasses (powder) | 35 |
| Acrylic Copolymers | 10 |
| Water | 10 |

The process for obtaining the chemical compound of the present invention obeys the following sequential steps:

1^{st}) Separating the compounds (vinasse, molasses—powder, acrylic copolymers) and the water in concentrations of 45%, 35%, 10% and 10%, respectively;

2^{nd}) Feeding the vinasse compound into a mixer;

3^{rd}) Feeding the molasses (powder) compound into the mixer;

4^{th}) Feeding the acrylic copolymers compound into the mixer;

5^{th}) Feeding the water into the mixer;

6^{th}) Mixing the compounds with the water) for a period of ten (10) minutes; and

7^{th}) Obtaining the poly-coat chemical compound.

The poly-coat compound allows for great benefits by decreasing the quantity of fertilizer to be applied in the soil, significantly decreasing the losses by lixiviation, volatilization or fixation due to the implemented logic of gradual release of polymer

1-4. (canceled)

5. A process for obtaining a poly-coat chemical compound applied for fixation of polymeric-nature elements in fertilizers, the process comprising the steps of:
(a) feeding vinasse, powder molasses, acrylic copolymers and water in concentrations of 45%, 35%, 10% and 10% respectively, into a mixer;
(b) mixing the compounds and the water in the mixer for a period of ten minutes; and
(c) obtaining a poly-coat chemical compound.

6. A poly-coat chemical compound produced according to the process of claim 5, the product comprising of:
(i) 45% vinasse;
(ii) 35% powder molasses;
(iii) 10% acrylic copolymers, and
(iv) 10% water.

7. The poly-coat chemical compound produced according to claim 6,wherein the compound is mixed to any kind of fertilizer.
